(19) United States
(12) Patent Application Publication
(10) Pub. No.: US 2024/0110086 A1
(43) Pub. Date: Apr. 4, 2024

(54) Refrigerants, Heat Transfer Compositions and Heat Transfer Systems and Methods

(71) Applicant: HONEYWELL INTERNATIONAL INC., Charlotte, NC (US)

(72) Inventors: Henna TANGRI, Charlotte, NC (US); Ankit SETHI, Charlotte, NC (US); Nilesh PUROHIT, Charlotte, NC (US); Aaditya Saikiran PEGALLAPATI, Charlotte, NC (US); Nitin KARWA, Charlotte, NC (US); Ryan HULSE, Charlotte, NC (US)

(73) Assignee: HONEYWELL INTERNATIONAL INC., Charlotte, NC (US)

(21) Appl. No.: 18/374,456

(22) Filed: Sep. 28, 2023

Related U.S. Application Data
(60) Provisional application No. 63/421,136, filed on Oct. 31, 2022.
(60) Provisional application No. 63/412,193, filed on Sep. 30, 2022.

(51) Int. Cl. C09K 5/04; F25B 45/00

(52) U.S. Cl. CPC C09K 5/045; F25B 45/00; F25B 2345/001; F25B 2345/003

(57) ABSTRACT

Novel non-flammable refrigerants having a GWP of less than 750 and containing R-32, R-125, R-134a and R-1234yf, and novel air conditioning systems (including heat pumps) which use such refrigerants, and method of retrofitting standard single refrigerant vapor compression air conditioning systems using said refrigerants, including especially residential heat pumps and residential split direct expansion air conditioning systems.

### CROSS REFERENCE

The present invention relates to, claims the priority benefit of, and incorporates by reference each U.S. Provisional Applications 63/421,136, filed Oct. 31, 2022 and 63/412,193, filed Sep. 30, 2022.

### FIELD

The present invention relates to high efficiency, low-global warming potential (“low GWP”), non-flammable refrigerants and to air conditioning and/or refrigeration systems and methods for providing cooling or heating that are safe and effective, including refrigerants and refrigeration/air conditioning systems and methods that have exceptional performance as replacements and retrofits for R-410A in air conditioning and particularly for R-410A in split direct expansion systems.

### BACKGROUND

The refrigeration industry is under increasing pressure—through regulatory changes and otherwise—to replace high global warming potential (GWP) refrigerants, such as R410A, with lower GWP refrigerants. Under many current regulations, and regulations that are contemplated for the future, refrigerants need to have a GWP below 750. The use of refrigerants with GWP values of below 750 is of particularly importance in the residential air conditioning systems, and in such uses potential negative environment impact is very great if refrigerants with substantially higher GWP are used. The high GWP refrigerant R-410A has a GWP of 2088 and has frequently been used in residential air conditioning systems.

One approach has been to use low GWP refrigerants, such as carbon dioxide (R744) and hydrocarbon refrigerants in a typical vapor compression system. However, such an approach as has been heretofore used can suffer from significant safety and financial drawbacks, such as: poor system energy efficiency, leading to increased operating costs; high system complexity, leading to high initial system costs; low system serviceability and reliability, leading to high maintenance costs; and high system flammability. Systems which include highly flammable refrigerants according to prior arrangements have been particularly disadvantageous as they can lead to poor levels of safety; can conflict with regulatory code restrictions; and can increase liability on refrigeration system operators and manufacturers. Safety is a particular concern given that residential air conditioning applications operate in occupied spaces. Thus, while the refrigerant R410A is nonflammable and therefore safe to use inside a residence (by virtue of the evaporator being located inside the residence), it has a significant disadvantage of being a high GWP refrigerant, that is, having a GWP of much greater than 750. However, many low GWP refrigerants which have been proposed to replace R410A in such systems suffer from an equally disadvantageous property of being flammable. As such, residential air conditioning systems which use such proposed flammable fluids create the risk of flammable atmospheres inside the residence in a situation where a leak may occur in the evaporator area.

EP 2367601 discloses a large number of potential refrigerants as replacements for a variety of existing refrigerants, including R-410A. Included among the proposed refrigerants is a blend comprising, 50 wt. % of HFO-1234yf, 40 wt. % of HFC-32, 5 wt. % of HFC-125 and 5 wt. % of HFC-134a, which blend is disclosed to have a GWP of 519. While such a blend has a GWP substantially lower than R-410A, it has the serious deficiency of not being non-flammable, that is, not being a Class A1 refrigerant. EP 2367601 also discloses generally a possible refrigerant comprising 50 wt. % of HFO-1234yf, 5 wt. % of HFC-32, 7 wt. % of HFC-125% and 38 wt. % of HFC-134a, but this blend is not a possible low GWP replacement for R-410A as described herein since it has a GWP substantially above 750. Furthermore, this blend is not disclosed for use in a particular application.

Applicants have come to appreciate that the residential air conditioning industry continues to need safe, robust, and sustainable solutions that reduce the use of high GWP refrigerants, and in particular for Class A1 refrigerants that have a GWP below 750, and applicants have addressed this need by developing novel refrigerants and novel air conditioning systems (including heat pumps) which use such refrigerants to provide a close capacity match to the use of R-410 in a standard single refrigerant vapor compression air conditioning system, including especially residential heat pumps and residential split direct expansion air conditioning systems that can operate as a heat pump.

Applicants have found, as described in detail hereinafter, that certain refrigerant blends comprising a carefully selected combination of components in specific concentrations can have an advantageous but unexpected combination of non-flammability while at the same time having excellent heat transfer properties, low GWP (e.g., a GWP of less than about 750), low- or no-toxicity and chemical stability, among others. Furthermore, Applicants have found that the refrigerant compositions of the present invention have particular advantage in split residential air conditioning systems (including residential heat pumps) and in connection with methods for retrofitting existing split direct expansion residential air conditioning systems (including particularly those that have a reversing valve that allows operation in a heating mode) to produce therefrom a secondary loop air conditioning system to use such new refrigerants to achieve advantageous results.

These and other unmet needs in the prior art are satisfied by the present invention, as explained in detail herein.

### SUMMARY

Applicants have discovered refrigerant compositions, heat transfer compositions comprising the refrigerant, heat transfer methods and systems, including residential air conditioning methods and systems, and methods of retrofitting existing residential heat pump systems.

The refrigerants of the present invention include refrigerants that have a GWP of less than about 750, are classified as A1 (non-flammable and low toxicity) by ASHRAE, and preferably have an evaporator glide of from about 0° C. to less than 5° C.

The present invention includes refrigerants comprising at least about 95% by weight, based on all refrigerant components, of the following four components:
(a) from about 50.5% to about 52.5% by weight of HFO-1234yf,
(b) from about 35.5% to 41% by weight of HFC-134a;
(c) from 2.2% to 5.5% by weight of HFC-125; and
(d) from 3.8% to about 8% by weight of HFC-32, with said percentages being based on the total of (a) through (d).
   The refrigerant according to this paragraph is sometimes referred to herein for convenience as Refrigerant 1.

The present invention also includes refrigerants consisting essentially of:
from about 50.5% to about 52.5% by weight of HFO-1234yf,
from about 35.5% to 41% by weight of HFC-134a;
from 2.2% to 5.5% by weight of HFC-125; and
from 3.8% to about 8% by weight of HFC-32.
   The refrigerant according to this paragraph is sometimes referred to herein for convenience as Refrigerant 2.

The present invention also includes refrigerants consisting essentially of:
from 51% to 52.5% by weight of HFO-1234yf,
from 35.8% to 37.8% by weight of HFC-134a;
from 4.5% to 5.5% by weight of HFC-125; and
from 6% to 8% by weight of HFC-32.
   The refrigerant according to this paragraph is sometimes referred to herein for convenience as Refrigerant 3A.

The present invention also includes refrigerants consisting of:
from 51% to 52.5% by weight of HFO-1234yf,
from 35.8% to 37.8% by weight of HFC-134a;
from 4.5% to 5.5% by weight of HFC-125; and
from 6% to 8% by weight of HFC-32.

The refrigerant according to this paragraph is sometimes referred to herein for convenience as Refrigerant 3B. The present invention also includes refrigerants consisting essentially of:
52%+0.5/−0.5% by weight of HFO-1234yf,
39%+0.5/−0.5% by weight of HFC-134a;
3%+0.3/−0.5% by weight of HFC-125; and
6%+0.5/−0.3% by weight of HFC-32.
   The refrigerant according to this paragraph is sometimes referred to herein for convenience as Refrigerant 3B.

The present invention also includes refrigerants consisting of:
52%+0.5/−0.5% by weight of HFO-1234yf,
39%+0.5/0.5% by weight of HFC-134a;
3%+0.3/0.5% by weight of HFC-125; and
6%+0.5/−0.3% by weight of HFC-32.
   The refrigerant according to this paragraph is sometimes referred to herein for convenience as Refrigerant 3C.

The present invention also includes refrigerants consisting essentially of:
51.4%+0.5/−0.5% by weight of HFO-1234yf,
40.4%+0.5/−0.5% by weight of HFC-134a;
4.1%+0.3/−0.5% by weight of HFC-125; and
4.1%+0.5/−0.3% by weight of HFC-32.
   The refrigerant according to this paragraph is sometimes referred to herein for convenience as Refrigerant 3D.

The present invention also includes refrigerants consisting of:
51.4%+0.5/−0.5% by weight of HFO-1234yf,
40.4%+0.5/−0.5% by weight of HFC-134a;
4.1%+0.3/−0.5% by weight of HFC-125; and
4.1%+0.5/−0.3% by weight of HFC-32.
   The refrigerant according to this paragraph is sometimes referred to herein for convenience as Refrigerant 3E.

The present invention also includes refrigerants consisting essentially of:
51.3%+0.5/−0.5% by weight of HFO-1234yf,
36%+0.5/−0.5% by weight of HFC-134a;
5.2%+0.3/−0.5% by weight of HFC-125; and
7.5%+0.5/−0.3% by weight of HFC-32.
   The refrigerant according to this paragraph is sometimes referred to herein for convenience as Refrigerant 3F.

The present invention also includes refrigerants consisting of:
51.3%+0.5/−0.5% by weight of HFO-1234yf,
36%+0.5/−0.5% by weight of HFC-134a;
5.2%+0.3/−0.5% by weight of HFC-125; and
7.5%+0.5/−0.3% by weight of HFC-32.
   The refrigerant according to this paragraph is sometimes referred to herein for convenience as Refrigerant 3G.

The present invention also includes refrigerants consisting essentially of:
from 45% to 47% by weight of HFO-1234yf,
from 36% to 37% by weight of HFC-134a;
from 4.5% to 5.5% by weight of HFC-125;
from 7% to 8% by weight of HFC-32; and
about 5% by weight of HFO-1234ze(E).
   The refrigerant according to this paragraph is sometimes referred to herein for convenience as Refrigerant 4A.

The present invention also includes refrigerants consisting essentially of:
about 46% by weight of HFO-1234yf,
about 36.5% by weight of HFC-134a;
about 5% by weight of HFC-125;
about 7.5% by weight of HFC-32; and
about 5% by weight of HFO-1234ze(E).
   The refrigerant according to this paragraph is sometimes referred to herein for convenience as Refrigerant 4B.

The present invention also includes refrigerants consisting essentially of:
46%+0.5/−0.5% by weight of HFO-1234yf,
36.5%+0.5/−0.5% by weight of HFC-134a;
5%+0.3/−0.5% by weight of HFC-125;
7.5%+0.5/−0.3% by weight of HFC-32; and
5%+0.5/−0.5% by weight of HFO-1234ze(E).
   The refrigerant according to this paragraph is sometimes referred to herein for convenience as Refrigerant 4C.

The present invention also includes refrigerants consisting of:
46%+0.5/−0.5% by weight of HFO-1234yf,
36.5%+0.5/−0.5% by weight of HFC-134a;
5%+0.3/−0.5% by weight of HFC-125;
7.5%+0.5/−0.3% by weight of HFC-32; and
5%+0.5/−0.5% by weight of HFO-1234ze(E).
   The refrigerant according to this paragraph is sometimes referred to herein for convenience as Refrigerant 4D.

The present invention also provides refrigerants comprising at least about 95% by weight of all refrigerant components of the following four components:
(a) from about 50.5% to about 52.5% by weight of HFO-1234yf,
(b) from about 35.5% to 41% by weight of HFC-134a;
(c) from 2.2% to 5.5% by weight of HFC-125; and
(d) from 3.8% to about 8% by weight of HFC-32, with said percentages being based on the total of (a) through (d), provided that the refrigerant has a GWP of less than 750 and is a Class A1 non-flammable refrigerant.
   The refrigerant according to this paragraph is sometimes referred to herein for convenience as Refrigerant 5A.

The present invention also provides refrigerants comprising at least about 95% by weight of all refrigerant components of the following four components:
(a) from about 50.5% to about 52.5% by weight of HFO-1234yf,
(b) from about 35.5% to 41% by weight of HFC-134a;
(c) from 2.2% to 5.5% by weight of HFC-125; and
(d) from 3.8% to about 8% by weight of HFC-32, with said percentages being based on the total of (a) through (d), provided that the refrigerant has a GWP of less than 750, is a Class A1 non-flammable refrigerant and has an evaporator glide from from 0° C. to about 5° C.
   The refrigerant according to this paragraph is sometimes referred to herein for convenience as Refrigerant 5B.

The present invention includes a secondary loop air conditioning system for heating and/or cooling the indoor air in a residence comprising:
(a) an pumped indoor heat transfer circuit comprising:
   an indoor refrigerant having a Class A1 flammability and having a GWP of about 750 or less;
   an indoor heat exchanger for exchanging heat with the air in the residence; and
   a liquid pump for moving said indoor refrigerant in the liquid phase in said indoor circuit;
(b) a vapor compression outdoor heat transfer circuit comprising: an outdoor refrigerant;
   a compressor for compressing said outdoor refrigerant in the vapor phase; and
   an expansion valve for reducing the pressure of said outdoor refrigerant in the liquid phase; and
   an outdoor heat exchanger for exchanging heat with outdoor air; and
(c) an inter-circuit heat exchanger in which said indoor refrigerant exchanges heat with said outdoor refrigerant
   For the purposes of convenience, systems in accordance with this paragraph are sometimes referred to herein as Heat Transfer System 1.

The present invention includes a secondary loop air conditioning system for heating and/or cooling indoor air comprising:
(a) a pumped indoor heat transfer circuit comprising:
   a. at least about 95% by weight based on all refrigerant components of
      1. from about 50% to about 52.5% by weight of HFO-1234yf,
      2. from about 35.5% to about 41% by weight of HFC-134a;
      3. from 2.2% to 5.5% by weight of HFC-125; and
      4. from 3.8% to about 8% by weight of HFC-32, with said percentages being based on the total of (1.) through (4.);
   b. an indoor heat exchanger for absorbing heat from said indoor air in the cooling mode and for adding heat to the indoor air in the heating mode;
   c. a liquid pump for moving said indoor refrigerant in the liquid phase to said indoor heat exchanger;
(b) a vapor compression outdoor heat transfer circuit comprising:
   a. an outdoor refrigerant;
   b. a compressor for compressing said outdoor refrigerant in the vapor phase;
   c. an expansion valve for reducing the pressure of said outdoor refrigerant in the liquid phase;
   d. an outdoor heat exchanger for exchanging heat with outdoor air; and
   e. a reversing valve connected to the outlet of said compressor and to said outdoor heat exchanger; and
(c) an inter-circuit heat exchanger in which said indoor refrigerant exchanges heat with said outdoor refrigerant, wherein said reversing valve directs the outdoor refrigerant vapor from said compressor to said inter-circuit heat exchanger or to said outdoor heat exchanger.
   For the purposes of convenience, systems in accordance with this paragraph are sometimes referred to herein as Heat Transfer System 2.

The present invention includes a secondary loop air conditioning system for heating and/or cooling indoor air comprising:
(a) a pumped indoor heat transfer circuit comprising:
   a. a refrigerant consisting essentially of:
      1. about 49% by weight of difluoromethane (HFC-32),
      2. about 11.5% by weight pentafluoroethane (HFC-125), and
      3. about 39.5% by weight of trifluoroiodomethane (CF3I);
   b. an indoor heat exchanger for absorbing heat from said indoor air in the cooling mode and for adding heat to the indoor air in the heating mode;
   c. a liquid pump for moving said indoor refrigerant in the liquid phase to said indoor heat exchanger;
(b) a vapor compression outdoor heat transfer circuit comprising:
   a. an outdoor refrigerant;
   b. a compressor for compressing said outdoor refrigerant in the vapor phase;
   c. an expansion valve for reducing the pressure of said outdoor refrigerant in the liquid phase;
   d. an outdoor heat exchanger for exchanging heat with outdoor air; and
   e. a reversing valve connected to the outlet of said compressor and to said outdoor heat exchanger; and
(c) an inter-circuit heat exchanger in which said indoor refrigerant exchanges heat with said outdoor refrigerant, wherein said reversing valve directs the outdoor refrigerant vapor from said compressor to said inter-circuit heat exchanger or to said outdoor heat exchanger.
   For the purposes of convenience, systems in accordance with this paragraph are sometimes referred to herein as Heat Transfer System 3.

The present invention includes methods of providing heating and/or cooling to the indoor air in a residence comprising:
(a) providing an indoor refrigerant comprising at least about 95% by weight of the following components based on all refrigerant components:
   a. from about 50.5% to about 52.5% by weight of HFO-1234yf,
   b. from about 35.5% to 41% by weight of HFC-134a;
   c. from 2.2% to 5.5% by weight of HFC-125; and
   d. from 3.8% to about 8% by weight of HFC-32, with said percentages being based on the total of a. through d.; and
(b) heating or cooling said indoor air by exchanging heat with said indoor refrigerant.
   The method according to this paragraph is sometimes referred to herein for convenience as Heat Transfer Method 1.

The present invention also includes a method of providing heating and/or cooling indoor air in a residence comprising:
(a) providing a pumped indoor heat transfer circuit comprising:
   a. an indoor refrigerant having a Class A1 flammability and having a GWP of about 750 or less;
   b. an indoor heat exchanger for exchanging heat with the air in the residence; and
   c. a liquid pump for moving said indoor refrigerant in the liquid phase in said indoor circuit;
(b) providing a vapor compression outdoor heat transfer circuit comprising:
   a. an outdoor refrigerant;
   b. a compressor for compressing said outdoor refrigerant in the vapor phase; and
   c. an expansion valve for reducing the pressure of said outdoor refrigerant in the liquid phase; and
   d. an outdoor heat exchanger for exchanging heat with outdoor air;
(c) exchanging heat between said indoor refrigerant and said outdoor refrigerant.
   The method according to this paragraph is sometimes referred to herein for convenience as Heat Transfer Method 2.

The present invention includes methods of providing heating and/or cooling to the indoor air in a residence comprising:
(a) providing a pumped indoor heat transfer circuit comprising:
   a. a refrigerant consisting essentially of:
      1. about 49% by weight of difluoromethane (HFC-32),
      2. about 11.5% by weight pentafluoroethane (HFC-125), and
      3. about 39.5% by weight of trifluoroiodomethane (CF3I);
   b. an indoor heat exchanger for absorbing heat from said indoor air in the cooling mode and for adding heat to the indoor air in the heating mode;
   c. a liquid pump for moving said indoor refrigerant in the liquid phase to said indoor heat exchanger;
(b) heating or cooling said indoor air by exchanging heat with said indoor refrigerant.
   For the purposes of convenience, systems in accordance with this paragraph are sometimes referred to herein as Heat Transfer Method 3.

The present invention includes methods of retrofitting an existing residential heat pump air conditioning system that uses a vapor compression cycle with R410a as the refrigerant and a reversing valve to provide heating or cooling to the indoor air in a residence, said method comprising:
(a) providing an existing heat pump system comprising:
   a. a compressor;
   b. an outdoor heat exchanger for exchanging heat between outdoor air and said R410A refrigerant;
   c. an indoor heat exchanger for exchanging heat between indoor air and said R410A refrigerant;
   d. a reversing valve connected to the inlet and to the outlet of said compressor and to each of said outdoor heat exchanger and said indoor heat exchanger;
   e. an expansion valve connected between said outdoor and said indoor heat exchanger;
(b) disconnecting said indoor heat exchanger from said expansion valve and from said reversing valve;
(c) providing an inter-circuit heat exchanger and connecting said inter-circuit heat exchanger to said expansion valve and said reversing valve to provide a flow path of R410A refrigerant therethrough;
(d) creating a pumped secondary refrigerant loop comprising said indoor heat exchanger, a liquid pump and said inter-circuit heat exchanger by connecting said pump to each of said inter-circuit heat exchanger and said indoor coil; and
(e) providing in said pumped secondary circuit an indoor refrigerant comprising at least about 95% by weight of the following components based on all refrigerant components:
   a. from about 50.5% to about 52.5% by weight of HFO-1234yf,
   b. from about 35.5% to 41% by weight of HFC-134a;
   c. from 2.2% to 5.5% by weight of HFC-125; and
   d. from 3.8% to about 8% by weight of HFC-32, with said percentages being based on the total of a. through d.
      The method according to this paragraph is sometimes referred to herein for convenience as Retrofit Method 1A.

The present invention includes methods of retrofitting an existing residential heat pump air conditioning system that uses a vapor compression cycle with R410a as the refrigerant and a reversing valve to provide heating or cooling to the indoor air in a residence, said method comprising:
(a) providing an existing heat pump system comprising:
   a. a compressor;
   b. an outdoor heat exchanger for exchanging heat between outdoor air and said R410A refrigerant;
   c. an indoor heat exchanger for exchanging heat between indoor air and said R410A refrigerant;
   d. a reversing valve connected to the inlet and to the outlet of said compressor and to each of said outdoor heat exchanger and said indoor heat exchanger;
   e. fluid flow lines connecting said expansion valve to said indoor heat exchanger and said indoor heat exchanger to said reversing valve;
(b) disconnecting said indoor heat exchanger from said expansion valve and from said reversing valve;
(c) providing an inter-circuit heat exchanger and using a substantial portion of said fluid flow lines to connect said inter-circuit heat exchanger to said expansion valve and said reversing valve to provide a flow path of R410A refrigerant therethrough;
(d) creating a pumped secondary refrigerant loop comprising said indoor heat exchanger, a liquid pump and said inter-circuit heat exchanger by connecting said pump to each of said inter-circuit heat exchanger and said indoor coil; and
(e) providing in said pumped secondary circuit an indoor refrigerant comprising at least about 95% by weight of the following components based on all refrigerant components:
   a. from about 50.5% to about 52.5% by weight of HFO-1234yf,
   b. from about 35.5% to 41% by weight of HFC-134a;
   c. from 2.2% to about 5.5% by weight of HFC-125; and
   d. from 3.8% to about 8% by weight of HFC-32, with said percentages being based on the total of a. through d.
      The method according to this paragraph is sometimes referred to herein for convenience as Retrofit Method 1B.

The present invention includes methods of retrofitting an existing residential heat pump air conditioning system that uses a vapor compression cycle with R410a as the refrigerant and a reversing valve to provide heating or cooling to the indoor air in a residence, said method comprising:
(f) providing an existing heat pump system comprising:
   a. a compressor;
   b. an outdoor heat exchanger for exchanging heat between outdoor air and said R410A refrigerant;
   c. an indoor heat exchanger for exchanging heat between indoor air and said R410A refrigerant;
   d. a reversing valve connected to the inlet and to the outlet of said compressor and to each of said outdoor heat exchanger and said indoor heat exchanger;
   e. an expansion valve connected between said outdoor and said indoor heat exchanger;
(g) disconnecting said indoor heat exchanger from said expansion valve and from said reversing valve;
(h) providing an inter-circuit heat exchanger and connecting said inter-circuit heat exchanger to said expansion valve and said reversing valve to provide a flow path of R410A refrigerant therethrough;
(i) creating a pumped secondary refrigerant loop comprising said indoor heat exchanger, a liquid pump and said inter-circuit heat exchanger by connecting said pump to each of said inter-circuit heat exchanger and said indoor coil; and
(j) providing in said pumped secondary circuit an indoor refrigerant comprising at least about 95% by weight of the following components based on all refrigerant components:
   a. about 49% by weight of HFC-32,
   b. about 11.5 by weight of HFC-125; and
   c. about 39.5% by weight of CF3I.
      The method according to this paragraph is sometimes referred to herein for convenience as Retrofit Method 2.

The present invention includes methods of retrofitting an existing residential heat pump air conditioning system that uses a vapor compression cycle with R410a as the refrigerant and a reversing valve to provide heating or cooling to the indoor air in a residence, said method comprising:
(a) providing an existing heat pump system comprising:
   a. a compressor;
   b. an outdoor heat exchanger for exchanging heat between outdoor air and said R410A refrigerant;
   c. an indoor heat exchanger for exchanging heat between indoor air and said R410A refrigerant;
   d. a reversing valve connected to the inlet and to the outlet of said compressor and to each of said outdoor heat exchanger and said indoor heat exchanger;
   e. an expansion valve connected between said outdoor and said indoor heat exchanger;
(b) disconnecting said indoor heat exchanger from said expansion valve and from said reversing valve;
(c) providing an inter-circuit heat exchanger and connecting said inter-circuit heat exchanger to said expansion valve and said reversing valve to provide a flow path of R410A refrigerant therethrough;
(d) creating a pumped secondary refrigerant loop comprising said indoor heat exchanger, a liquid pump and said inter-circuit heat exchanger by connecting said pump to each of said inter-circuit heat exchanger and said indoor coil; and
(e) providing in said pumped secondary circuit an indoor refrigerant having a Class A1 flammability and having a GWP of about 750 or less.
   The method according to this paragraph is sometimes referred to herein for convenience as Retrofit Method 2A.

The present invention includes methods of retrofitting an existing residential heat pump air conditioning system that uses a vapor compression cycle with R410a as the refrigerant and a reversing valve to provide heating or cooling to the indoor air in a residence, said method comprising:
(a) providing an existing heat pump system comprising:
   a. a compressor;
   b. an outdoor heat exchanger for exchanging heat between outdoor air and said R410A refrigerant;
   c. an indoor heat exchanger for exchanging heat between indoor air and said R410A refrigerant;
   d. a reversing valve connected to the inlet and to the outlet of said compressor and to each of said outdoor heat exchanger and said indoor heat exchanger;
   e. an expansion valve connected between said outdoor and said indoor heat exchanger;
   f. fluid flow lines connecting said expansion valve to said indoor heat exchanger and said indoor heat exchanger to said reversing valve;
(b) disconnecting said indoor heat exchanger from said expansion valve and from said reversing valve;
(c) providing an inter-circuit heat exchanger and using a substantial portion of said fluid flow lines to connect said inter-circuit heat exchanger to said expansion valve and to said reversing valve to provide a flow path of R410A refrigerant therethrough;
(d) creating a pumped secondary refrigerant loop comprising said indoor heat exchanger, a liquid pump and said inter-circuit heat exchanger by connecting said pump to each of said inter-circuit heat exchanger and said indoor coil; and
(e) providing in said pumped secondary circuit an indoor refrigerant having a Class A1 flammability and having a GWP of about 750 or less.
   The method according to this paragraph is sometimes referred to herein for convenience as Retrofit Method 2B.

### BRIEF DESCRIPTION OF THE FIGURES

FIG. 1A is a schematic representation of an exemplary residential air conditioning system of the present invention in the cooling mode.

FIG. 1B is a schematic representation of an exemplary residential air conditioning system of the present invention in the heating mode.

FIG. 2A is a schematic representation of a typical residential heat pump system, operating in the cooling mode, that is subject to the retrofitting methods of the present invention.

FIG. 2B is a schematic representation of a typical residential heat pump system, operating in the heating mode, that is subject to the retrofitting methods of the present invention.

### DETAILED DESCRIPTION

### Definitions

The phrase “coefficient of performance” (hereinafter “COP”) is a universally accepted measure of refrigerant system performance, especially useful in representing the relative thermodynamic efficiency of a refrigerant system in a specific heating or cooling cycle involving evaporation or condensation of the refrigerant. In refrigeration engineering, this term expresses the ratio of useful refrigeration or cooling capacity to the energy applied by the compressor(s) in compressing the vapor and therefore expresses the capability of a given compressor(s) to pump quantities of heat for a given volumetric flow rate of a heat transfer fluid, such as a refrigerant. In other words, given a specific compressor(s), a refrigerant with a higher COP will deliver more cooling or heating power. One means for estimating COP of a refrigerant in a system at specific operating conditions is from the thermodynamic properties of the refrigerant using standard refrigeration cycle analysis techniques (see for example, R. C. Downing, FLUOROCARBON REFRIGERANTS HANDBOOK, Chapter 3, Prentice-Hall, 1988 which is incorporated herein by reference in its entirety). The term “capacity” is the amount of cooling provided, in BTUs/hr., by the refrigerant in the refrigeration system. This is experimentally determined by multiplying the change in enthalpy in BTU/lb., of the refrigerant as it passes through the evaporator by the mass flow rate of the refrigerant. The enthalpy can be determined from the measurement of the pressure and temperature of the refrigerant. The capacity of the refrigeration system relates to the ability to maintain an area to be cooled at a specific temperature. The capacity of a refrigerant represents the amount of cooling or heating that it provides and provides some measure of the capability of a compressor(s) to pump quantities of heat for a given volumetric flow rate of refrigerant. In other words, given a specific compressor(s), a refrigerant with a higher capacity will deliver more cooling or heating power.

The phrase “Global Warming Potential” (hereinafter “GWP”) was developed to allow comparisons of the global warming impact of different gases. It compares the amount of heat trapped by a certain mass of a gas to the amount of heat trapped by a similar mass of carbon dioxide over a specific period of time. Carbon dioxide was chosen by the Intergovernmental Panel on Climate Change (IPCC) as the reference gas and its GWP is taken as 1. The larger GWP, the more that a given gas warms the Earth compared to CO2 over that time period. As used herein, the term GWP means the value of GWP as measured in accordance with IPCC Fourth Assessment Report, 2014¹, referred to and abbreviated herein as AR4. ¹ Myhre, G., D. Shindell, F.-M. Bréon, W. Collins, J. Fuglestvedt, J. Huang, D. Koch, J.-F. Lamarque, D. Lee, B. Mendoza, T. Nakajima, A. Robock, G. Stephens, T. Takemura and H. Zhang, 2013: Anthropogenic and Natural Radiative Forcing. In: Climate Change 2013: The Physical Science Basis. Contribution of Working Group I to the Fifth Assessment Report of the Intergovernmental Panel on Climate Change [Stocker, T. F., D. Qin, G.-K. Plattner, M. Tignor, S. K. Allen, J. Boschung, A. Nauels, Y. Xia, V. Bex and P. M. Midgley (eds.)]. Cambridge University Press, Cambridge, United Kingdom and New York, NY, USA. https://www.ipcc.ch/pdf/assessmentreport/ar4/wg1/WG1AR4_Chapter08_FINAL.pdf (p. 73-79)

The term “non-flammable” refers to compounds or compositions which are determined to be nonflammable as determined in accordance with ASTM Standard E-681-2009 Standard Test Method for Concentration Limits of Flammability of Chemicals (Vapors and Gases) at conditions described in ASHRAE Standard 34-2016 Designation and Safety Classification of Refrigerants and described in Appendix 1 to ASHRAE Standard 34-2016 (as each standard exists as of the filing date of this application), which are incorporated herein by reference in its entirety (“Non-Flammability Test”). Flammability is defined as the ability of a composition to ignite and/or propagate a flame. Under this test, flammability is determined by measuring flame angles. A non-flammable substance would be classified as class “1” by ASHRAE Standard 34-2016 Designation and Safety Classification of Refrigerants test protocol defining conditions and apparatus and using the current method ASTM E681-09 annex A1 (as each standard exists as of the filing date of this application).

As used herein, the term “evaporator glide” means the difference between the saturation temperature of the refrigerant at the entrance to the evaporator and the dew point of the refrigerant at the exit of the evaporator, assuming the pressure at the evaporator exit is the same as the pressure at the inlet. As used herein, the phrase “saturation temperature” means the temperature at which the liquid refrigerant boils into vapor at a given pressure.

The phrase “no or low toxicity” as used herein means the composition is classified as class “A” by ASHRAE Standard 34-2016 Designation and Safety Classification of Refrigerants and described in Appendix 1 to ASHRAE Standard 34-2016 (as each standard exists as of the filing date of this application). A substance which is non-flammable and low-toxicity would be classified as “A1” by ASHRAE Standard 34-2016 Designation and Safety Classification of Refrigerants and described in Appendix 1 to ASHRAE Standard 34-2016 (as each standard exists as of the filing date of this application).

The term “degree of superheat” or simply “superheat” means the temperature rise of the refrigerant at the exit of the evaporator above the saturated vapor temperature (or dew temperature) of the refrigerant.

As used herein, the term “E-1,3,3,3-tetrafluoropropene” means the trans isomer of HFO-1234ze and is abbreviated as HFO-1234ze (E).

As used herein, the term “2,3,3,3-tetrafluoropropene” is abbreviated as HFO-1234yf.

As used herein, the term “1,1,1,2-tetrafluoroethane” is known in the industry by the abbreviation HFC-134a and is abbreviated herein as HFC-134a. As used herein, the term “pentafluoroethane” is known in the industry by the abbreviation HFC-125 and is abbreviated herein as HFC-125.

As used herein, the term “difluoromethane” is known in the industry by the abbreviation HFC-32 and is abbreviated herein as HFC-32.

As used herein, the term “chlorodifluoromethane” is known in the industry by the abbreviation R-22 and is abbreviated herein as R-22.

As used herein, the term “trifluoroiodomethane” means CF₃I and is abbreviated as CF3I.

As used herein, the term “residential air conditioning” refers to a refrigeration system that operates with a heat exchanger that absorbs heat from or adds heat to the indoor air in a structure in which humans reside.

As used herein, the term “split direct expansion air conditioning system” refers to an air conditioning system that operates with an indoor unit that is located inside the residence and contains a heat exchanger that absorbs heat from or adds heat to the indoor air in a structure in which humans reside and with an outdoor unit that includes a heat exchanger located outside the residence that rejects heat to or absorbs heat from outdoor air.

As used herein, the term “secondary loop air conditioning system” refers to an air conditioning system having an inside refrigeration circuit using an indoor (or secondary) refrigerant to heat and/or cool the inside air and an outside refrigeration circuit that uses an outdoor (or primary) refrigerant that is different than the indoor refrigerant and that rejects heat to or absorbs heat from the outside air.

As used herein, the term “suction line” used in connection with a secondary loop air conditioning system refers to refrigerant flow path from the outlet of the intermediate heat exchanger to the inlet of the compressor.

As used herein, the term “liquid line” used in connection with a secondary loop air conditioning system refers to refrigerant flow path from the outlet of the condenser to the inlet of the intermediate heat exchanger.

As used herein, the term “R410A” means the refrigerant designated by ASHRAE as 410A and which consists of 50%+2/−2% of R-32 and 50%+2/−2% of HFC-125.

As used herein, the term “R454B” means the refrigerant designated by ASHRAE as 454B and which consists of 69.9%+2/−2% of R-32 and 31.1+2/−2% of HFC-1234yf.

As used herein, the term “R466A” means the refrigerant designated by ASHRAE as 466A and which consists of 49%+0.5/−2.0% of R-32, 11.5%+2.0/−0.5% of HFC-125, and 39.5%+2.0/−0.5% of CF3I.

As used herein, the term “about” in relation to the amount expressed in weight percent means that the amount of the component can vary by an amount of +/−2% by weight.

Refrigerants and Heat Transfer Compositions:

Applicants have found that the refrigerants of the present invention, including each of Refrigerants 1-5 as described herein, are unexpectedly capable of providing a set of exceptionally advantageous properties including: excellent heat transfer properties, acceptable toxicity and nonflammability (i.e., is Class 1A), zero or near zero ozone depletion potential (“ODP”) and preferably relatively low evaporator glide, that is, from 0° C. to less than 5° C.

As used herein, reference to a numbered refrigerant, system or method, or a group of such numbered refrigerants, systems and methods, that have been defined herein means each such numbered systems, including each system having a number within the group, including any suffixed numbered system. For example, reference to Refrigerant 4 includes reference to each of Refrigerants 4A, 4B, 4C and 4D.

A particular advantage of the refrigerants of the present invention, including specifically each of Refrigerants 1-5, is that they are nonflammable and have acceptable toxicity, that is, each is a Class A1 refrigerant. It will be appreciated by the skilled person that the flammability of a refrigerant can be a characteristic that is given consideration in certain important heat transfer applications, and that refrigerants that are classified as Class A1 can frequently be an advantage over refrigerants that are not Class A1. Thus, it is a desire in the art to provide a refrigerant composition which can be used as a replacement for prior non-flammable refrigerants, including R410A and R-22 which has excellent heat transfer properties, acceptable toxicity, zero or near zero ODP. This combination of desirable advantages is achieved by the refrigerants of the present invention, including specifically each of Refrigerants 1-5, and further in connection with the use of such refrigerants in the systems of the present invention, including Systems 1 and 2, and in the methods of the present invention, including Methods 1 and 2.

Applicants have found that the refrigerant compositions of the invention, including each of Refrigerants 1-5, achieve a difficult-to-achieve combination of properties including particularly a GWP of 750 or less and Class A1 flammability.

In addition, the refrigerant compositions of the invention, including each of Refrigerants 1-5, have a zero or near zero ODP. Thus, the compositions of the invention have an ODP of not greater than 0.02, and more preferably zero.

In addition, the refrigerant compositions of the invention, including each of Refrigerants 1-5, have acceptable toxicity and preferably have an OEL of greater than about 400. As those skilled in the art are aware, a non-flammable refrigerant that has an OEL of greater than about 400 is advantageous since it results in the refrigerant being classified in the desirable Class A of ASHRAE standard 34.

The preferred refrigerant compositions of the invention, including each of Refrigerants 1-5, have both acceptable toxicity and nonflammability under ASHRAE standard 34, and are therefore Class A1 refrigerants. Applicants have found that the heat transfer compositions of the present invention, including heat transfer compositions that include each of Refrigerants 1-5 as described herein, are capable of providing an exceptionally advantageous and unexpected combination of properties including: good heat transfer properties, acceptable toxicity, nonflammability, and zero or near zero ozone depletion potential (“ODP”), and chemical stability under the conditions of use, including over the operating temperature ranges used in air conditioning, and in particular in residential air conditioning.

### Methods, Uses and Systems

Systems

The present invention includes heat transfer systems of all types that include refrigerants of the present invention, including each of Refrigerants 1-5. Heat transfer systems as described in this paragraph are sometimes referred to for convenience as Heat Transfer System 3.

The present invention also includes, and provides particular advantage in connection with, secondary loop air conditioning systems that include refrigerants of the present invention, including each of Refrigerants 1-5, in the indoor loop of such systems. Heat transfer systems as described in this paragraph are sometimes referred to for convenience as Heat Transfer System 4.

The present invention also includes, and provides particular advantage in connection with, secondary loop residential air conditioning systems that include refrigerants of the present invention, including each of Refrigerants 1-5, in the indoor loop of such systems. Heat transfer systems as described in this paragraph are sometimes referred to for convenience as Heat Transfer System 5.

Methods—Heat Transfer Methods

The present invention includes heat transfer methods of all types that include refrigerants of the present invention, including each of Refrigerants 1-5. Heat transfer methods as described in this paragraph are sometimes referred to for convenience as Heat Transfer Methods 3.

The present invention also includes, and provides particular advantage in connection with, heat transfer methods that are carried out in secondary loop air conditioning systems that include refrigerants of the present invention, including each of Refrigerants 1-5, in the indoor loop of such systems. Heat transfer methods as described in this paragraph are sometimes referred to for convenience as Heat Transfer Methods 4.

The present invention also includes, and provides particular advantage in connection with, heat transfer methods that are carried out in secondary loop residential air conditioning systems that include refrigerants of the present invention, including each of Refrigerants 1-5, in the indoor loop of such systems. Heat transfer systems as described in this paragraph are sometimes referred to for convenience as Heat Transfer Methods 5.

Methods—Retrofit Methods

The present invention includes retrofit methods based on an existing split direct expansion vapor compression air conditioning system. The existing system, prior to being subject to the present invention, uses the same existing high GWP refrigerant, including R410A or R-22, in both the indoor and outdoor units. According to the present retrofit methods, the existing system is modified such that the secondary loop (indoor) system uses a refrigerant of the present invention, including each of Refrigerants 1-5 in place of the previously used existing refrigerant. Retrofit methods as described in this paragraph are sometimes referred to for convenience as Retrofit Methods 3.

The present invention includes retrofit methods based on an existing split direct expansion vapor compression air conditioning system which includes a reversing valve allowing operation of the system in a heating mode and a cooling mode. The existing system, prior to being subject to the present invention, uses an existing high GWP refrigerant, including R410A or R-22, in the indoor and outdoor units to produce a secondary loop air conditioning system that can operate in a heating mode or a cooling mode. According to the present retrofit methods, the existing system is modified such that the the refrigerant in the indoor (secondary) loop is a refrigerant of the present invention, including each of Refrigerants 1-5. Retrofit methods as described in this paragraph are sometimes referred to for convenience as Retrofit Methods 4.

The present invention includes retrofit methods based on existing split direct expansion vapor compression air conditioning systems which include inter-unit refrigerant piping between the indoor unit and the outdoor unit, a reversing valve allowing operation of the system in a heating mode, and an existing high GWP refrigerant, including R410A or R-22, in the indoor and outdoor units. According to the present retrofit methods, the existing system is modified, without replacing a major portion of said inter-unit piping a secondary loop system in which the refrigerant in the indoor (secondary) loop is a refrigerant of the present invention, including each of Refrigerants 1-5. Retrofit methods as described in this paragraph are sometimes referred to for convenience as Retrofit Methods 5.

The present invention includes retrofit methods based on an existing split direct expansion vapor compression air conditioning system which includes inter-unit refrigerant piping between the indoor unit and the outdoor unit, a reversing valve allowing operation of the system in a heating mode and in a cooling mode, and an existing high GWP refrigerant, including R410A or R-22, in the indoor and outdoor units. According to the present retrofit methods, the existing system is modified, without replacing a major portion of said inter-unit piping, a secondary loop system in which the refrigerant in the secondary loop is a refrigerant of the present invention, including each of Refrigerants 1-5. Retrofit methods as described in this paragraph are sometimes referred to for convenience as Retrofit Methods 6.

The present invention includes retrofit methods based on an existing split direct expansion vapor compression air conditioning system which includes inter-unit refrigerant piping between the indoor unit and the outdoor unit, a reversing valve allowing operation of the system in a heating mode or a cooling mode, and an existing high GWP refrigerant, including R410A or R-22, in the indoor and outdoor units. According to the present retrofit methods, the existing system is modified, without replacing a major portion of said inter-unit piping, a secondary loop system in which: (i) the refrigerant in the secondary loop is a refrigerant of the present invention, including each of Refrigerants 1-5; (ii) the drop of saturation temperature in the suction line is 2° F. or less; and (iii) the drop of saturation temperature in the liquid line is 1° F. or less. Retrofit methods as described in this paragraph are sometimes referred to for convenience as Retrofit Methods 7A.

The present invention includes retrofit methods based on an existing split direct expansion vapor compression air conditioning system which includes a reversing valve allowing operation of the system in a heating mode or a cooling mode, and an existing high GWP refrigerant, including R410A or R-22, in the indoor and outdoor units. According to the present retrofit methods, the existing system is modified to produce a secondary loop system in which: (i) the refrigerant in the secondary loop is a refrigerant of the present invention, including each of Refrigerants 1-5; (ii) the capacity is at least about 90% of the capacity of said existing split direct expansion vapor compression air conditioning system; and (iii) the COP is at least about 90% of the COP of said existing split direct expansion vapor compression air conditioning system. Retrofit methods as described in this paragraph are sometimes referred to for convenience as Retrofit Methods 7B.

The present invention includes retrofit methods based on an existing split direct expansion vapor compression air conditioning system which includes inter-unit refrigerant piping between the indoor unit and the outdoor unit, a reversing valve allowing operation of the system in a heating mode or a cooling mode, and an existing high GWP refrigerant, including R410A or R-22, in the indoor and outdoor units. According to the present retrofit methods, the existing system is modified, without replacing a major portion of said inter-unit piping, a secondary loop system in which: (i) the refrigerant in the secondary loop is a refrigerant of the present invention, including each of Refrigerants 1-5; (ii) the capacity is at least about 90% of the capacity of said existing split direct expansion vapor compression air conditioning system; (iii) the COP is at least about 90% of the COP of said existing split direct expansion vapor compression air conditioning system; (iv) the drop of saturation temperature in the suction line is 2° F. or less; and (v) the drop of saturation temperature in the liquid line is 1° F. or less. Retrofit methods as described in this paragraph are sometimes referred to for convenience as Retrofit Methods 7C.

The present invention includes retrofit methods based on an existing split direct expansion vapor compression air conditioning system which includes: (i) a reversing valve allowing operation of the system in a heating mode or a cooling mode; (ii) an existing high GWP refrigerant, including R410A or R-22, in the indoor and outdoor units; (iii) an existing compressor; and (iv) an existing outdoor heat exchanger. According to the present retrofit methods, the existing system is modified such that: (i) the refrigerant in the secondary loop is a refrigerant of the present invention, including each of Refrigerants 1-5; (ii) the compressor in the outdoor unit has a displacement that is from about 4% to about 96% greater than the displacement of the compressor in the existing system; and (iii) the outdoor heat exchanger has a heat transfer surface that is from about 16% to about 68% greater than the area of the outdoor heat exchanger in the existing system. Retrofit methods as described in this paragraph are sometimes referred to for convenience as Retrofit Methods 7D.

The present invention includes retrofit methods based on an existing split direct expansion vapor compression air conditioning system which includes: (i) inter-unit refrigerant piping between the indoor unit and the outdoor unit; (ii) a reversing valve allowing operation of the system in a heating mode; (iii) an existing high GWP refrigerant, including R410A or R-22, in the indoor and outdoor units; (iv) an existing compressor; and (v) an existing outdoor heat exchanger. According to the present retrofit methods, the existing system is modified, without replacing a major portion of said inter-unit piping, to produce a secondary loop system in which: (i) the refrigerant in the secondary loop is a refrigerant of the present invention, including each of Refrigerants 1-5; (ii) the compressor in the outdoor unit has a displacement that is from about 4% to about 96% greater than the displacement of the compressor in the existing system; (iii) the outdoor heat exchanger has a heat transfer surface that is from about 16% to about 68% greater than the area of the outdoor heat exchanger in the existing system; (iv) the drop of saturation temperature in the suction line is 2° F. or less; and (v) the drop of saturation temperature in the liquid line is 1° F. or less. Retrofit methods as described in this paragraph are sometimes referred to for convenience as Retrofit Methods 7E.

The present invention includes retrofit methods based on an existing split direct expansion vapor compression air conditioning system which includes inter-unit refrigerant piping between the indoor unit and the outdoor unit, a reversing valve allowing operation of the system in a heating mode or a cooling mode, an expansion valve in the outdoor unit, and an existing high GWP refrigerant, including R410A or R-22, in the indoor and outdoor units. According to the present retrofit methods, the existing system is modified to produce, without replacing a major portion of said inter-unit piping, a secondary loop system in which: (i) the refrigerant in the secondary loop is a refrigerant of the present invention, including each of Refrigerants 1-5; (ii) a replacement expansion valve is introduced into the system and operates in the outdoor loop; (iii) the drop of saturation temperature in the suction line is 2° F. or less; and (iv) the drop of saturation temperature in the liquid line is 1° F. or less. Retrofit methods as described in this paragraph are sometimes referred to for convenience as Retrofit Methods 7A.

The present invention includes retrofit methods based on an existing split direct expansion vapor compression air conditioning system which includes a reversing valve allowing operation of the system in a heating mode or a cooling mode, an expansion valve in the outdoor unit, and an existing high GWP refrigerant, including R410A or R-22, in the indoor and outdoor units. According to the present retrofit methods, the existing system is modified to produce a secondary loop system in which: (i) the refrigerant in the secondary loop is a refrigerant of the present invention, including each of Refrigerants 1-5; (ii) a replacement expansion valve is introduced into the system and operates in the outdoor loop; (iii) the capacity is at least about 90% of the capacity of said existing split direct expansion vapor compression air conditioning system; and (iv) the COP is at least about 90% of the COP of said existing split direct expansion vapor compression air conditioning system. Retrofit methods as described in this paragraph are sometimes referred to for convenience as Retrofit Methods 7B.

The present invention includes retrofit methods based on an existing split direct expansion vapor compression air conditioning system which includes inter-unit refrigerant piping between the indoor unit and the outdoor unit, a reversing valve allowing operation of the system in a heating mode or a cooling mode, an expansion valve in the outdoor unit, and an existing high GWP refrigerant, including R410A or R-22, in the indoor and outdoor units. According to the present retrofit methods, the existing system is modified to produce, without replacing a major portion of said inter-unit piping, a secondary loop system in which: (i) the refrigerant in the secondary loop is a refrigerant of the present invention, including each of Refrigerants 1-5; (ii) a replacement expansion valve is introduced into the system and operates in the outdoor loop; (iii) the capacity is at least about 90% of the capacity of said existing split direct expansion vapor compression air conditioning system; (iv) the COP is at least about 90% of the COP of said existing split direct expansion vapor compression air conditioning system; (v) the drop of saturation temperature in the suction line is 2° F. or less; and (vi) the drop of saturation temperature in the liquid line is 1° F. or less. Retrofit methods as described in this paragraph are sometimes referred to for convenience as Retrofit Methods 7C.

The present invention includes retrofit methods based on an existing split direct expansion vapor compression air conditioning system which includes: (i) a reversing valve allowing operation of the system in a heating mode or a cooling mode; (ii) an expansion valve in the outdoor unit, (iii) an existing high GWP refrigerant, including R410A or R-22, in the indoor and outdoor units; (iv) an existing compressor; and (v) an existing outdoor heat exchanger. According to the present retrofit methods, the existing system is modified such that: (i) the refrigerant in the secondary loop is a refrigerant of the present invention, including each of Refrigerants 1-5; (ii) a replacement expansion valve is introduced into the system and operates in the outdoor loop; (iii) the compressor in the outdoor unit has a displacement that is from about 4% to about 96% greater than the displacement of the compressor in the existing system; and (iv) the outdoor heat exchanger has a heat transfer surface that is from about 16% to about 68% greater than the area of the outdoor heat exchanger in the existing system. Retrofit methods as described in this paragraph are sometimes referred to for convenience as Retrofit Methods 7D.

The present invention includes retrofit methods based on an existing split direct expansion vapor compression air conditioning system which includes: (i) inter-unit refrigerant piping between the indoor unit and the outdoor unit; (ii) a reversing valve allowing operation of the system in a heating mode; (iii) an existing high GWP refrigerant, including R410A or R-22, in the indoor and outdoor units; (iv) an existing compressor; (v) an expansion valve in the outdoor unit, and (vi) an existing outdoor heat exchanger. According to the present retrofit methods, the existing system is modified to produce, without replacing a major portion of said inter-unit piping, to produce a secondary loop system in which: (i) the refrigerant in the secondary loop is a refrigerant of the present invention, including each of Refrigerants 1-5; (ii) the compressor in the outdoor unit has a displacement that is from about 4% to about 96% greater than the displacement of the compressor in the existing system; (iii) the outdoor heat exchanger has a heat transfer surface that is from about 16% to about 68% greater than the area of the outdoor heat exchanger in the existing system; (iv) a replacement expansion valve is introduced into the system and operates in the outdoor loop; (v) the drop of saturation temperature in the suction line is 2° F. or less; and (vi) the drop of saturation temperature in the liquid line is 1° F. or less. Retrofit methods as described in this paragraph are sometimes referred to for convenience as Retrofit Methods 7E.

Uses

The present invention includes use of the refrigerants of the present invention, including each of Refrigerants 1-5, to provide heating and/or cooling to a fluid or body. Uses as described in this paragraph are sometimes referred to for convenience as Heat Transfer Use 1.

The present invention also includes, and provides particular advantage in connection with, use of the refrigerants of the present invention, including each of Refrigerants 1-5, to provide heating and/or cooling in secondary loop air conditioning systems in the indoor loop of such systems. Uses as described in this paragraph are sometimes referred to for convenience as Heat Transfer Use 2.

The present invention also includes, and provides particular advantage in connection with, use of the refrigerants of the present invention, including each of Refrigerants 1-5, to provide heating and/or cooling in secondary loop residential air conditioning systems that include refrigerants of the present invention, including each of Refrigerants 1-5, in the indoor loop of such systems. Uses as described in this paragraph are sometimes referred to for convenience as Heat Transfer Use 3.

The present invention includes use of the refrigerants of the present invention, including each of Refrigerants 1-5, to retrofit an existing single refrigerant vapor compression heat pump which uses an existing refrigerant, including R410A or R-22, to produce a pumped secondary loop system in which the refrigerant in the pumped secondary loop is a refrigerant of the present invention, including each of Refrigerants 1-5. Uses as described in this paragraph are sometimes referred to for convenience as Retrofit Use 1.

The present invention includes use of the refrigerants of the present invention, including each of Refrigerants 1-5, to retrofit an existing single refrigerant vapor compression heat pump air conditioning system which uses an existing refrigerant, including R410A or R-22, to produce a pumped secondary loop system in which the refrigerant in the pumped secondary loop is a refrigerant of the present invention, including each of Refrigerants 1-5. Uses as described in this paragraph are sometimes referred to for convenience as Retrofit Use 2.

The present invention includes use of the refrigerants of the present invention, including each of Refrigerants 1-5, to retrofit an existing single refrigerant residential vapor compression heat pump air conditioning system which uses an existing refrigerant, including R410A or R-22, to produce a pumped secondary loop system in which the refrigerant in the pumped secondary loop is a refrigerant of the present invention, including each of Refrigerants 1-5. Uses as described in this paragraph are sometimes referred to for convenience as Retrofit Use 3.

Exemplary Heat Transfer Systems, Methods and Uses

As described in detail below, the preferred methods, uses and systems of the present invention comprise or use a secondary loop air conditioning arrangement. In such arrangements, an outdoor loop comprises a compressor, a condenser, an expansion device and an evaporator, all connected in fluid communication using piping, valving and control systems such that the outdoor refrigerant and associated components of the heat transfer composition can flow through the system in known fashion to complete the vapor compression refrigeration cycle. The indoor loop comprises pumped liquid refrigerant system comprising a liquid refrigerant of the present invention, including each of Refrigerants 1-5, a pump for moving said liquid refrigerant in said loop, and a heat exchanger for exchanging heat between the indoor refrigerant and the indoor air.

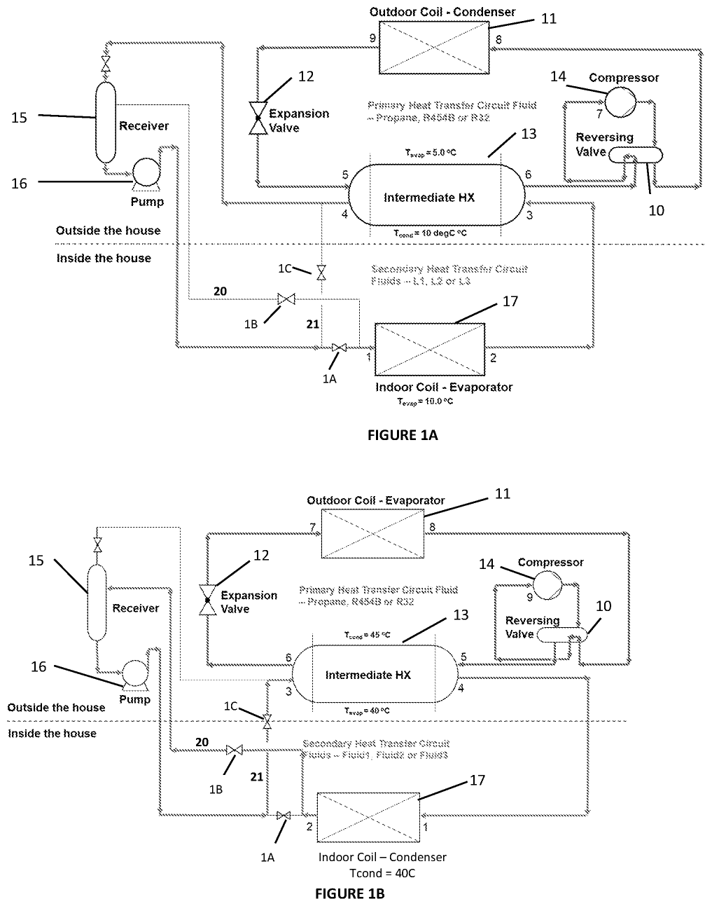

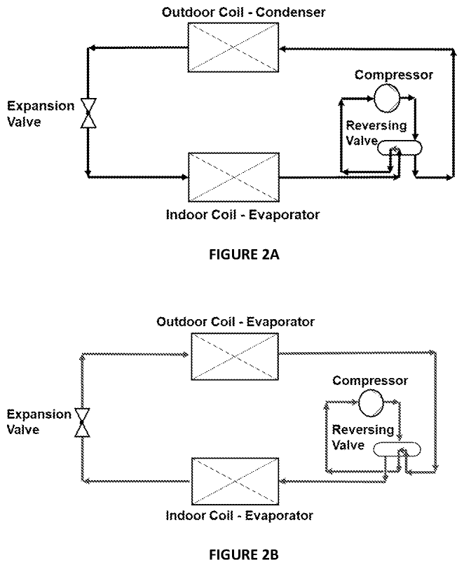

An exemplary schematic of a heat transfer system of the present invention is illustrated in FIG. 1A showing operation in the cooling mode and in FIG. 1B showing operation in the heating mode. For the purposes of convenience, operation in the cooling mode is described first in connection with reference to FIG. 1A, which shows a compressor 14 providing compressed outdoor refrigerant vapor through reversing valve 10 and line 8 to outdoor heat exchanger 11, which acts in the cooling mode as a condenser for rejecting heat to outdoor ambient air. The compressed refrigerant vapor is condensed in heat exchanger 11 to produce a liquid outdoor refrigerant which is directed via line 9 to an expansion device, such as expansion valve 12, that produces liquid outdoor refrigerant at reduced temperature and pressure, which in turn is then provided through line 5 to inter-circuit heat exchanger 13. In preferred embodiments, the expansion valve 12 is a replacement expansion valve, that is, the expansion valve from the existing system is not used during operation by either fixing the existing valve in the open position, bypassing the existing valve or removing the existing valve. In this regard, an with particular reference to FIGS. 2A and 2b, it is noted that in typical existing R410A systems the expansion valve is upstream of the indoor evaporator coil and is physically located indoors near the indoor coil/evaporator. Since the preferred retrofit methods of the present invention include creating an indoor loop that is a pumped loop, an indoor expansion valve will generally not be present. On the other hand, the outdoor loop according to present retrofit methods will be a vapor compression loop, and in this a case an expansion valve is required. Accordingly, installation of a replacement expansion valve located outdoors is a preferred step according to the present retrofit methods. Furthermore, those skilled in the art will appreciate from the teachings contained herein that since the outdoor refrigerant which is formed by the present invention will not be R410A, the particular design characteristics of the replacement expansion valve in such cases are preferably selected for desired operation in the outdoor loop with the replacement refrigerant used in the outdoor loop according to the present invention.

Referring once again to FIGS. 1A and 1B, although the inter-circuit heat exchanger 13 is shown in the preferred position in FIGS. 1A and 1B as being located outside of the residence, it will be appreciated that in other embodiments the inter-circuit heat exchanger could be located inside the residence. In the cooling mode, inter-circuit heat exchanger 13 acts as an evaporator for the outdoor refrigerant, where it absorbs heat from the secondary (indoor) refrigerant of the present invention, including Refrigerants 1-10, preferably via the pumped secondary circuit comprising at least a portion of lines 1-4 as shown in FIG. 1A. This absorption of heat by the outdoor refrigerant from the indoor refrigerant in the intermediate heat exchanger 13 thus produces outdoor refrigerant vapor, which is transmitted through line 6 to reversing valve 10 and then to the suction line 7 of the compressor 14.

The indoor refrigerant of the present invention, including Refrigerants 1-10, circulate through a pumped secondary loop comprising a receiver 15, a pump 16 and indoor heat exchanger 17. In the cooling mode, indoor heat exchanger 17 acts as an evaporator which produces indoor refrigerant vapor via line 2, which in turn is transmitted via line 3 to the inter-circuit heat exchanger 13. In the inter-circuit heat exchanger 13 in the cooling mode, the indoor refrigerant vapor is condensed to produce indoor refrigerant liquid to line 4, which is then directed to receiver 15. The receiver 15 directs indoor refrigerant liquid to pump 16, which provides energy for circulation of the refrigerant through the circuit, and in particular to the indoor heat exchanger through line 1. Preferably the indoor loop includes a flow valve (which preferably is a control valve 1A operated by an appropriate control circuit (not shown) which is open in the cooling mode to allow indoor refrigerant to flow from the pump 16 to the evaporator 17. On the other hand, the valves 1B and 1C valve (which preferably are also control valves operated by an appropriate control circuit (not shown)) in lines 20 and 21, respectively, are closed during operation in the cooling mode, but are opened in the heating mode, as disclosed in detail below.

Operation in the heating mode is now described in connection with reference to FIG. 1B, compressor 14 provides compressed outdoor refrigerant vapor through reversing valve 10 and line 5 to the inter-circuit heat exchanger 13, which acts in the heating mode as a condenser for rejecting heat to the secondary (indoor) refrigerant of the present invention, including Refrigerants 1-10, preferably via the pumped secondary circuit as shown in FIG. 1B. The liquid outdoor refrigerant condensed in inter-circuit heat exchanger 13 is transmitted via line 6 to an expansion device, such as expansion valve 12, that produces liquid outdoor refrigerant at reduced temperature and pressure, which in turn is then provided through line 7 to outdoor heat exchanger 11. In preferred embodiments, the expansion valve 12 is a replacement expansion valve, that is, the expansion valve from the existing system is not used during operation by either fixing the existing valve in the open position, bypassing the existing valve or removing the existing valve. In the outdoor heat exchanger 11, the liquid outdoor refrigerant absorbs heat from the outdoor ambient air to produce outdoor refrigerant vapor, which in turn is directed vial line 8 to the reversing valve 10, which then directs the flow of vapor to the inlet of compressor 14 via line 9. The compressed outdoor refrigerant vapor passes through reversing valve 10 and line 5 to the inter circuit heat exchanger 13 which acts as a condenser in the heating mode for rejecting heat to secondary refrigerant. The compressed refrigerant vapor is condensed in inter-circuit heat exchanger 13 to produce a liquid outdoor refrigerant by rejecting heat to the indoor refrigerant in the indoor circuit, as described in detail below.

In the heating mode, the indoor refrigerant of the present invention, including Refrigerants 1-5, circulate through the same pumped secondary loop as used in the cooling mode, namely receiver 15, pump 16 and indoor heat exchanger 17, except with the flow path being modified as illustrated in FIG. 1B and described herein. In the heating mode, the pumped circuit operates with valve 1A in the closed position, with valves 1B and 1C being open. In this configuration, the flow of the indoor liquid refrigerant is directed from receiver 15 to pump 16 but is directed via line 21 and valve 1C to line 3 leading to the inter-circuit heat exchanger 13, where it absorbs heat from the outdoor refrigerant. Thus, in the heating mode, the inter-circuit heat exchanger acts as an evaporator for the indoor refrigerant of the present invention, including each of Refrigerants 1-5, and produces indoor refrigerant vapor. The indoor refrigerant vapor is transmitted via line 4 from the inter-circuit heat exchanger 13 to the indoor heat exchanger 17, where it rejects heat to the indoor air, thus providing heating to the residence. Accordingly, in the heating mode, the indoor coil acts as a condenser for the indoor refrigerant of the present invention. The condensed liquid from the indoor heat exchanger 17 is then directed via line 2 and valve 1B to receiver 15.

### EXAMPLES

In the examples which follow, refrigerant compositions in accordance with the present invention are identified as compositions L1-L4 in Table E below and composition L5, which is R466A, is also used in accordance with the heat transfer systems and the heat transfer methods. Each of the L1-L5 refrigerants was tested and evaluated by applicants and found to be non-flammable, that is, to be a Class A1 refrigerant, and each of L1-L5 was also subjected to thermodynamic analysis to determine its ability to match performance of R-410A when used in a single refrigerant vapor compression heat pump air conditioning system. The analysis was performed using experimental data collected for properties of various binary and ternary pairs of components used in the refrigerant. The composition of each pair was varied over a series of relative percentages in the experimental evaluation and the mixture parameters for each pair were regressed to the experimentally obtained data. Known vapor/liquid equilibrium behavior data available in the National Institute of Science and Technology (NIST) Reference Fluid Thermodynamic and Transport Properties Database software (Refprop 9.1 NIST Standard Database 23 from April 2016) was used for the Examples. Each blend was also evaluated to determine its classification for flammability as described above.

TABLE E
Refrigerants of The Invention Tested for Performance

| | R1234yf) | R134a | R125 | R32 | R1234ze(E) | | GWP | |
|---|---|---|---|---|---|---|---|---|
| Refrigerant | Wt. % | | | | | CF3I | (AR4) | Flammability |
| L1 | 51.4 | 40.4 | 4.1 | 4.1 | 0 | 0 | 750 | A1 |
| L2 | 51.3 | 36 | 5.2 | 7.5 | 0 | 0 | 749 | A1 |
| L3 | 52 | 39 | 3 | 6 | 0 | 0 | 705 | A1 |
| L4 | 46 | 36.5 | 5.0 | 7.5 | 5 | 0 | 750 | A1 |
| L5 (R466A) | 0 | 0 | 11.5 | 49 | 0 | 39.5 | 733 | A1 |

As can be seen from Table E above, each of the refrigerants L1-L4 according to the present invention achieves a GWP value (AR4) of 750 or less while at the same time achieving a flammability of Class A1. This is also the case with R466A.

### Comparative Example 1—Single Refrigerant Residential Heat Pump Using R410A—Cooling Mode

A residential heat pump air conditioning system known as a ductless mini-split system using R410A as the single refrigerant and corresponding generally to the basic structure shown in FIG. 2A is operated in the cooling mode (as shown in FIG. 2A). The system comprises a compressor, an outdoor condenser, an expansion valve, an indoor evaporator, and the reversing valve. A as is typical in operation of systems of this type in the cooling mode, the reversing valve is set to direct high temperature vapor from the compressor to the inlet of the outdoor condenser wherein the vapor rejects heat to outdoor ambient air. Liquid refrigerant leaving the condenser is then directed to an expansion valve which reduces the pressure and creates a lower pressure refrigerant liquid which has a temperature below the temperature of the set point for the ambient air inside the residence. The cold liquid refrigerant leaving the expansion device is directed to the indoor evaporator. In the evaporator, heat is absorbed by the refrigerant as the cold refrigerant evaporates, thereby cooling the indoor air in the residence. The vapor stream from the evaporator is directed to the reversing valve, which is set to direct the flow of refrigerant vapor back to the suction side of the compressor. In a typical arrangement, both the compressor and the condenser are located outside of the residence, while the evaporator is located inside the residence. The basic operating conditions for the system of this comparative example are:
1. Refrigerant condensing temperature=45° C., corresponding outdoor ambient temperature=35° C.
2. Expansion device sub-cooling=5.0° C.
3. Refrigerant evaporating temperature=10° C., corresponding indoor room temperature=27° C.
4. Evaporator Superheat=5.0° C.
5. Volumetric Efficiency=100%
6. Isentropic Efficiency=74%
   For the purposes of relative comparison, the performance results in terms of capacity and efficiency are considered to be 100%, and compressor displacement and heat transfer surface area for the heat exchangers are considered to be 100%. and the compressor horse power is considered to be 100%.

### Example 1A—Secondary Loop Residential Heat Pump Using Various Low GWP

Refrigerants in the Outdoor Loop and Refrigerants L1-L5 in the Indoor Loop and Increased Compressor Displacement to Match Capacity

A mini-secondary residential air conditioning system of the present invention corresponding generally to the basic structure shown in FIG. 1A is operated in the cooling mode as describe herein. The system is testing using 15 different refrigerant pairings, namely, each of three different outdoor refrigerants (propane, R454B and R32) paired with four indoor refrigerants of the present invention, namely, L1, L2, L3 and L4, as well as L5, each as identified in Table E above. The system is configured to use in the outdoor loop essentially the same equipment as is used in Comparative Example 1, except for the compressor size is increased a sufficient amount to provide 100% capacity relative to Comparative Example 1, as identified in Table E1A below, and the expansion valve is a replacement expansion valve as described herein. The operating conditions are as indicted below:
1. Condensing temperature=45° C., corresponding outdoor ambient temperature=35° C.
2. Expansion device sub-cooling=5.0° C.
3. Evaporating temperature=5.0° C., corresponding indoor room temperature=27° C.
4. Evaporator Superheat=0.0° C. (flooded)
5. Intermediate Heat Exchanger Superheat=5.0° C.
6. Volumetric Efficiency=100%
7. Difference of saturation temperatures inter-circuit heat exchanger=5° C.
   Thus, the same operating conditions as used in Comparative Example 1 are used, except that the evaporating temperature of the refrigerant in the pumped indoor loop is 5° C., which is 5° C. lower than the temperature used in Comparative Example 1. The results are reported relative to the results from Comparative Example are reported in Table E1 below:

TABLE E1A

| | | |
|---|---|---|
| | | Performance - Relative |
| Outdoor | Indoor | to R410AA in Comparative |
| Refrigerant | Refrigerant | Example 1 |

| (GWP - AR4) | (GWP - AR4) | Capacity | Efficiency |
|---|---|---|---|
| R410A (2088) | — | 100% | 100.00% |
| Propane (3.3) | L1(750) | 100% | 87.86% |
| Propane (3.3) | L2 (749) | 100% | 87.86% |
| Propane (3.3) | L3 (705) | 100% | 87.86% |
| Propane (3.3) | L4 (750) | 100% | 87.86% |
| Propane (3.3) | L5 (733) | 100% | 87.86% |
| R454B (466) | L1 (750) | 100% | 84.42% |
| R454B (466) | L2 (749) | 100% | 84.42% |
| R454B (466) | L3 (705) | 100% | 84.42% |
| R454B (466) | L4 (750) | 100% | 84.42% |
| R454B (466) | L5 (733) | 100% | 84.42% |
| R32 (675) | L1 (750) | 100% | 84.86% |
| R32 (675) | L2(749) | 100% | 84.86% |
| R32 (675) | L3(705) | 100% | 84.86% |
| R32 (675) | L4 (750) | 100% | 84.86% |
| R32 (675) | L5 (733) | 100% | 84.86% |

### Example 1B—Secondary Loop Residential Heat Pump Using Various Low GWP Refrigerants in the Outdoor Loop and Refrigerants L1-L4 in the Indoor Loop and Increased Condenser Heat Transfer Surface to Improve Efficiency

The mini-secondary residential air conditioning system of the present invention as described in Example 1A is operated in the cooling mode as describe in Example 1A, except that: (1) the outdoor heat exchanger heat transfer area is increased relative to the condenser in Comparative Example 1 and the expansion valve is replaced as described in Example 1An; and (2) the condenser temperature is reduced relative to Comparative Example 1. The system is testing using 15 different refrigerant pairings, namely, each of three different outdoor refrigerants (propane, R454B and R32) paired with four indoor refrigerants of the present invention, namely, L1, L2, L3 and L4, as well as L5, each as identified in Table E above. The results are reported relative to the results from Comparative Example 1 are reported in Table E1 B below:

TABLE E1B

| | | Outdoor | Outdoor | | |
|---|---|---|---|---|---|
| | | (Condenser) | (Condenser) | Performance - | |
| | | Heat | Heat Exchange | Relative to R410A | |
| Outdoor | Indoor | Exchanger | Surface, % of | in Comparative | |
| Refrigerant | Refrigerant | Temp., | Comparative | Example 1 | |
| (GWP - AR4) | (GWP - AR4) | ° C. | Example 1 | Capacity | Efficiency |
| R410A (2088) | — | 45.00 | 100% | 100% | 100.00% |
| Propane (3.3) | L1(750) | 42.00 | 167.8% | 100% | 96.12% |
| Propane (3.3) | L2 (749) | 42.00 | 167.8% | 100% | 96.12% |
| Propane (3.3) | L3 (705) | 42.00 | 167.8% | 100% | 96.12% |
| Propane (3.3) | L4 (750) | 42.00 | 167.8 | 100% | 96.12% |
| Propane (3.3) | L5 (733) | 42.00 | 167.8% | 100% | 96.12% |
| R454B (466) | L1 (750) | 42.10 | 159.1% | 100% | 92.73% |
| R454B (466) | L2 (749) | 42.10 | 159.1% | 100% | 92.73% |
| R454B (466) | L3 (705) | 42.10 | 159.1% | 100% | 92.73% |
| R454B (466) | L4 (750) | 42.10 | 159.1% | 100% | 92.73% |
| R454B (466) | L5 (733) | 42.10 | 159.1% | 100% | 92.73% |
| R32 (675) | L1 (750) | 42.00 | 167.7% | 100% | 93.36% |
| R32 (675) | L2(749) | 42.00 | 167.7% | 100% | 93.36% |
| R32 (675) | L3(705) | 42.00 | 167.7% | 100% | 93.36% |
| R32 (675) | L4 (750) | 42.00 | 167.7% | 100% | 93.36% |
| R32 (675) | L5 (733) | 42.00 | 167.7% | 100% | 93.36% |

As illustrated by the results in Example 1 B, in each case the secondary loop system of the present invention is able to achieve an efficiency that is at least about 93%, and in the case of using propane as the outdoor refrigerant, an efficiency greater than 95%. This is an unexpected and highly desirable result in view of the dramatic reduction in the GWP of the refrigerants used in the inventive systems of the present invention.

### Example 1C—Secondary Loop Residential Heat Pump Using Various Low GWP Refrigerants in the Outdoor Loop and Refrigerants L1-L5 in the Indoor Loop and with High Efficiency Compressor

The mini-secondary residential air conditioning system of the present invention as described in Example 1B is operated in the cooling mode as described in Example B, except that a compressor with the same displacement but with a higher efficiency is used. In particular, the compressor used in this example has an efficiency that is about 2% higher than compressor of Example 1 B. The results are reported relative to the results from comparative Example 1 are reported in Table E1C below:

TABLE E1C

| | | | Outdoor | | | |
|---|---|---|---|---|---|---|
| | | | (Condenser) | | | |
| | | Outdoor | Heat | | Performance - | |
| | | (Condenser) | Exchange | | Relative to R410A in | |
| Outdoor | Indoor | Heat | Surface, % of | | Comparative | |
| Refrigerant | Refrigerant | Exchanger | Comparative | Isentropic | Example 1 | |
| (GWP - AR4) | (GWP - AR4) | Temp., ° C. | Example 1 | Efficiency | Capacity | Efficiency |
| R410A (2088) | — | 45.00 | 100% | 73.88% | 100% | 100.00% |
| Propane (3.3) | L1(750) | 42.00 | 167.8 | 72.00% | 100% | 96.12% |
| Propane (3.3) | L2 (749) | 42.00 | 167.8 | 72.00% | 100% | 96.12% |
| Propane (3.3) | L3 (705) | 42.00 | 167.8 | 72.00% | 100% | 96.12% |
| Propane (3.3) | L4 (750) | 42.00 | 167.8 | 72.00% | 100% | 96.12% |
| Propane (3.3) | L5 (733) | 42.00 | 167.8 | 72.00% | 100% | 96.12% |
| R454B (466) | L1 (750) | 42.10 | 158 | 74.30% | 100% | 95.00% |
| R454B (466) | L2 749) | 42.10 | 158 | 74.30% | 100% | 95.00% |
| R454B (466) | L3 (705) | 42.10 | 158 | 74.30% | 100% | 95.00% |
| R454B (466) | L4 (750) | 42.10 | 158 | 74.30% | 100% | 95.00% |
| R454B (466) | L5 (733) | 42.10 | 158 | 74.30% | 100% | 95.00% |
| R32 (675) | L1 (750) | 42.00 | 166.8 | 73.78% | 100% | 95.00% |
| R32 (675) | L2(749) | 42.00 | 166.8 | 73.78% | 100% | 95.00% |
| R32 (675) | L3(705) | 42.00 | 166.8 | 73.78% | 100% | 95.00% |
| R32 (675) | L4(750) | 42.00 | 166.8 | 73.78% | 100% | 95.00% |
| R32 (675) | L5(733) | 42.00 | 166.8 | 73.78% | 100% | 95.00% |

### Comparative Example 2—Single Refrigerant Residential Heat Pump Using R410A—Heating Mode

An residential heat pump air conditioning system known as a ductless mini-split system using R410A as the single refrigerant and corresponding generally to the basic structure shown in FIG. 2B is operated in the heating mode (as shown in FIG. 2B). The system comprises a compressor, an outdoor condenser, an expansion valve, an indoor evaporator, and the reversing valve. A as is typical in operation of systems of this type in the heating mode, the reversing valve is set to direct high temperature vapor from the compressor to the inlet of the indoor condenser, wherein hot vapor heats the indoor ambient air as it condenses in refrigerant liquid. Liquid refrigerant leaving the condenser is then directed to an expansion valve which reduces the pressure and creates a lower pressure refrigerant liquid which has a temperature below the temperature of outdoor ambient air. The cold liquid refrigerant leaving the expansion device is directed to the outdoor evaporator, and in the heating mode the cold refrigerant liquid absorbs heat to produce refrigerant vapor, which is directed by the reversing valve to the suction side of the compressor. In a typical arrangement, both the compressor and the evaporator are located outside of the residence, while the condenser is located inside the residence. The basic operating conditions for the system of this comparative example are:
1. Evaporating temperature=0.5° C., corresponding outdoor ambient temperature=8.3° C.
2. Evaporator Superheat=5.0° C.
3. Condensing temperature=40.0° C., corresponding indoor room temperature=21.1° C.
4. Expansion device sub-cooling=5.0° C.
5. Volumetric Efficiency=100%
   For the purposes of relative comparison, the performance results in terms of capacity and efficiency are considered to be 100%, and compressor displacement and heat transfer surface area for the heat exchangers are considered to be 100%.

### Example 2A—Secondary Loop Residential Heat Pump Using Various Low GWP Refrigerants in the Outdoor Loop and Refrigerants L1-L5 in the Indoor Loop and Increased Compressor Displacement to Match Capacity—Heating Mode

A mini-secondary residential air conditioning system of the present invention corresponding generally to the basic structure shown in FIG. 1B (which is the same as the system of FIG. 1A but operated in the heating mode as describe herein. The system is testing using 9 different refrigerant pairings, namely, each of three different outdoor refrigerants (propane, R454B and R32) paired with five indoor refrigerants of the present invention, namely, L1, L2, L3 and L4, as well as L4, each as identified in Table E above. The system is configured to use in the outdoor loop essentially the same equipment as is used in Comparative Example 2, except for the compressor size is increased a sufficient amount to provide 100% capacity relative to Comparative Example 2, as identified in Table E2A below, and the expansion valve is a replacement valve as described herein. The operating conditions are as indicted below:
1. Evaporating temperature=0.5° C., corresponding outdoor ambient temperature=8.3° C.
2. Ambient Temperature—Evaporating Temperature=7.8° C.
3. Evaporator Superheat=5.0° C.
4. Evaporating temperature=5.0° C., corresponding indoor room temperature=27° C.
5. Condensing temperature=45.0° C., corresponding indoor room temperature=21.1° C.
6. Expansion device sub-cooling=5.0° C.
7. Volumetric Efficiency=100%
8. Difference of saturation temperatures intermediate heat exchanger=5° C.
   Thus, the same operating conditions as used in Comparative Example 2 are used, except that the condensing temperature of the refrigerant in the pumped indoor loop is 45° C., which is 5° C. higher than the condensing temperature used in Comparative Example 2. The results are reported relative to the results from Comparative Example 2 are reported in Table E2A below:

TABLE E2A

| | | |
|---|---|---|
| | | Performance - Relative |
| Outdoor | Indoor | to R410A in Comparative |
| Refrigerant | Refrigerant | Example 2 |

| (GWP - AR4) | (GWP - AR4) | Capacity | Efficiency |
|---|---|---|---|
| R410A (2088) | — | 100% | 100.00% |
| Propane (3.3) | L1 (750) | 100% | 91.03% |
| Propane (3.3) | L2 (749) | 100% | 91.03% |
| Propane (3.3) | L3 (705) | 100% | 91.03% |
| Propane (3.3) | L4 (750) | 100% | 91.03% |
| Propane (3.3) | L5 (733) | 100% | 91.03% |
| R454B (466) | L1 (750) | 100% | 87.35% |
| R454B (466) | L2 (749) | 100% | 87.35% |
| R454B (466) | L3 (705) | 100% | 87.35% |
| R454B (466) | L4 (750) | 100% | 87.35% |
| R454B (466) | L5 (733) | 100% | 87.35% |
| R32 (675) | L1 (750) | 100% | 87.73% |
| R32 (675) | L2(749) | 100% | 87.73% |
| R32 (675) | L3(705) | 100% | 87.73% |
| R32 (675) | L4(750) | 100% | 87.73% |
| R32 (675) | L5(733) | 100% | 87.73% |

### Example 2B—Secondary Loop Residential Heat Pump Using Various Low GWP Refrigerants in the Outdoor Loop and Refrigerants L1-L5 in the Indoor Loop and Increased Evaporator Heat Transfer Surface to Improve Efficiency—Heating Mode

The mini-secondary residential air conditioning system of the present invention as described in Example 1A is operated in the heating mode as describe in Example 2A, except that: (1) the outdoor heat exchanger heat transfer area is increased relative to the evaporator in Comparative Example 2; and (2) the evaporator temperature is reduced relative to Example 2A. The system is tested using 9 different refrigerant pairings, namely, each of three different outdoor refrigerants (propane, R454B and R32) paired with five indoor refrigerants of the present invention, namely, L1, L2, L3 and L4, as well as L5, each as identified in Table E above. The results are reported relative to the results from Comparative Example 2 are reported in Table E2B below:

TABLE E2B

| | | Outdoor | Outdoor | | |
|---|---|---|---|---|---|
| | | (Evaporator) | (Evaporator) | Performance - | |
| | | Heat | Heat Exchange | Relative to R410A | |
| Outdoor | Indoor | Exchanger | Surface, % of | in Comparative | |
| Refrigerant | Refrigerant | Temp., | Comparative | Example 1 | |
| (GWP - AR4) | (GWP - AR4) | ° C. | Example 1 | Capacity | Efficiency |
| R410A (2088) | — | 0.5 | 100% | 100% | 100.00% |
| Propane (3.3) | L1(750) | 1.3 | 115.5% | 100% | 93.16% |
| Propane (3.3) | L2 (749) | 1.3 | 115.5% | 100% | 93.16% |
| Propane (3.3) | L3 (705) | 1.3 | 115.5% | 100% | 93.16% |
| Propane (3.3) | L4 (750) | 1.3 | 115.5 | 100% | 93.16% |
| Propane (3.3) | L5 (733) | 1.3 | 115.5 | 100% | 93.16% |
| R454B (466) | L1 (750) | 1.3 | 113.7% | 100% | 89.43% |
| R454B (466) | L2 (749) | 1.3 | 113.7% | 100% | 89.43% |
| R454B (466) | L3 (705) | 1.3 | 113.7% | 100% | 89.43% |
| R454B (466) | L4 (750) | 1.3 | 113.7 | 100% | 89.43% |
| R454B (466) | L5 (733) | 1.3 | 113.7% | 100% | 89.43% |
| R32 (675) | L1 (750) | 1.3 | 115.6% | 100% | 89.82% |
| R32 (675) | L2(749) | 1.3 | 115.6% | 100% | 89.82% |
| R32 (675) | L3(705) | 1.3 | 115.6% | 100% | 89.82% |
| R32 (675) | L4 (750) | 1.3 | 115.6 | 100% | 89.82% |
| R32 (675) | L5(733) | 1.3 | 115.6% | 100% | 89.82% |

As illustrated by the results in Example 2B, in each case the secondary loop system of the present invention is able to achieve an efficiency that is at least about 89%, and in the case of using propane as the outdoor refrigerant, an efficiency greater than 93%. This is an unexpected and highly desirable result in view of the dramatic reduction in the GWP of the refrigerants used in the inventive systems of the present invention and in view of exceptional performance achieved when the same system is operated in the cooling mode.

### Example 2C—Secondary Loop Residential Heat Pump Using Various Low GWP Refrigerants in the Outdoor Loop and Refrigerants L1-L5 in the Indoor Loop and with High Efficiency Compressor—Heating Mode

The mini-secondary residential air conditioning system of the present invention as described in Example 1B is operated in the cooling mode as described in Example 1B, except that the compressor with the same displacement but with a higher efficiency is used. In particular, the compressor used in this example has an efficiency that is about 2-5% higher than the compressor of Example 2B. The results are reported relative to the results from comparative Example 2 are reported in Table E2C below:

TABLE E2C

| | | | Outdoor | | | |
|---|---|---|---|---|---|---|
| | | | (Condenser) | | | |
| | | Outdoor | Heat | | Performance - | |
| | | (Evaporator) | Exchange | | Relative to R404A in | |
| Outdoor | Indoor | Heat | Surface, % of | | Comparative | |
| Refrigerant | Refrigerant | Exchanger | Comparative | Isentropic | Example 2 | |
| (GWP - AR5) | (GWP - AR5) | Temp., ° C. | Example 2 | Efficiency | Capacity | Efficiency |
| R410A (2088) | — | 0.5 | 100% | 73.7% | 100% | 100.00% |
| Propane (3.3) | L1 (750) | 1.3 | 116.3% | 74.70% | 100% | 95% |
| Propane (3.3) | L2 (749) | 1.3 | 116.3% | 74.70% | 100% | 95% |
| Propane (3.3) | L3 (705) | 1.3 | 116.3% | 74.70% | 100% | 95% |
| Propane (3.3) | L4 (750) | 1.3 | 116.3% | 74.70% | 100% | 95% |
| Propane (3.3) | L5 (733) | 1.3 | 116.3% | 74.70% | 100% | 95% |
| R454B (466) | L1 (750) | 1.3 | 116.0% | 77.70% | 100% | 95.00% |
| R454B (466) | L2 (749) | 1.3 | 116.0% | 77.70% | 100% | 95.00% |
| R454B (466) | L3 (705) | 1.3 | 116.0% | 77.70% | 100% | 95.00% |
| R454B (466) | L4 (750) | 1.3 | 116.0% | 77.70% | 100% | 95.00% |
| R454B (466) | L5 (733) | 1.3 | 116.0% | 77.70% | 100% | 95.00% |
| R32 (675) | L1 (750) | 1.3 | 117.8% | 77.30% | 100% | 95.00% |
| R32 (675) | L2 (749) | 1.3 | 117.8% | 77.30% | 100% | 95.00% |
| R32 (675) | L3 (705) | 1.3 | 117.8% | 77.30% | 100% | 95.00% |
| R32 (675) | L4 (750) | 1.3 | 117.8% | 77.30% | 100% | 95.00% |
| R32 (675) | L5 (733) | 1.3 | 117.8% | 77.30% | 100% | 95.00% |

### Example 3—Retrofit of Existing Single Refrigerant R-410A Heat Pump with Secondary Loop Residential Heat Pump Using Various Low GWP Refrigerants in the Outdoor Loop and Refrigerants L1-L5 in the Indoor Loop

An existing residential air conditioning/heat pump system using R410A and having the configuration illustrated in FIGS. 2A and 2B is provided. In the existing system, the following components are located in a unit located outdoors: compressor, reversing valve, outdoor heat exchanger (condenser) and expansion valve. Refrigerant flow lines to and from the outdoor unit circulate refrigerant to the indoor unit, which contains the indoor heat exchanger. The existing system has a capacity of 10.5 KW and has nominal operating parameters as follows:
1. Evaporating temperature=10° C., corresponding indoor ambient temperature=27° C.
2. Evaporator Superheat=5° C.
3. Condensing temperature=45° C., corresponding outdoor room temperature=35° C.
4. Expansion device sub-cooling=5.0° C.
5. Compressor isentropic efficiency=74%
6. Volumetric Efficiency=100%
7. Change in enthalpy=164 kJ/kg
8. Mass Flow Rate=0.064 kg/s
9. Volumetric Flow Rate=0.0016 m³/sec

The system is retrofitted by removing substantially all of the R-410A refrigerant from the system using standard industry techniques. The system is modified to have a configuration as illustrated in FIGS. 1A and 1B by disconnecting the refrigerant flow lines at or adjacent to the outdoor unit, but without replacing those refrigerant flow lines leading to and from the indoor unit. An intermediate heat exchanger, a receiver and a liquid pump as disclosed herein is added to the system and located in the indoor unit. The existing refrigerant flow lines leading to and from the indoor unit are used to allow the flow of refrigerant to/from the pump and to/from the inter-circuit heat exchanger are used to transport the indoor refrigerant between the pump and the indoor heat exchanger and between the inter-circuit heat exchanger and the indoor heat exchanger. The outdoor compressor displacement is increased and the outdoor heat exchanger surface area is increased as indicated in Examples 1A and 1B, and additional indoor refrigerant flow lines and valves are added as illustrated in FIGS. 1A and 1B to permit operation in the heating mode. The expansion valve is replaced as described herein. The retrofitted system operates with a mass flow rate of the indoor refrigerants L1-L5 based on a system capacity of 10.5 KW, evaporating temperature of 10° C., inlet quality of zero and outlet quality of 0.86. Performance of the retrofitted system in terms of delta enthalpy and mass and volume flow of indoor refrigerant through existing lines is reported in Table E3 below for each of the refrigerants L1-L4 of the present invention, as well as refrigerant L5, with operation in the original R-410A system being included in Table E3A for comparison:

TABLE E3A

| | | Delta | Mass Flow | Volumetric |
|---|---|---|---|---|
| | Capacity | Enthalpy | Rate | Flow Rate |
| | (kW) | kJ/kg | kg/s | m3/s |
| R410A | 10.5 | 164.2 | 0.064 | 0.0016 |
| L1 | 10.5 | 147.77 | 0.071 | 0.0022 |
| L2 | 10.5 | 150.95 | 0.069 | 0.0020 |
| L3 | 10.5 | 150.23 | 0.070 | 0.0021 |
| L4 | 10.5 | 152.1 | 0.069 | 0.0021 |
| L5 | 10.5 | 163.7 | 0.064 | 0.0020 |

Based on the operation as reported in Table E3A, operation with the existing refrigerant flow lines between the outdoor unit and the indoor unit in the retrofitted system is determined and reported in Table E3B below:

TABLE E3B

| | R410A | L1 | L2 | L3 | L4 | L5 |
|---|---|---|---|---|---|---|
| Flow Line | | | | | | |
| Information | | | | | | |
| Suction Line | 7.62 | 7.62 | 7.62 | 7.62 | 7.62 | 7.62 |
| Length (m) | | | | | | |
| Suction Line | 0.01905 | 0.01905 | 0.01905 | 0.01905 | 0.01905 | 0.01905 |
| Diameter (m) | | | | | | |
| Liquid Line | 7.62 | 7.62 | 7.62 | 7.62 | 7.62 | 7.62 |
| Length (m) | | | | | | |
| Liquid Line | 0.009525 | 0.009525 | 0.009525 | 0.009525 | 0.009525 | 0.009525 |
| Diameter (m) | | | | | | |
| Operating | | | | | | |
| Conditions | | | | | | |
| Volumetric Flow | 0.0016 | 0.0022 | 0.0020 | 0.0021 | 0.0021 | 0.0020 |
| Rate (m³/s) | | | | | | |
| Pressure Drop | 7.4 | 9.2 | 8.1 | 8.6 | 8.1 | 11.9 |
| Suction Line (kPa) | | | | | | |
| Delta Tsat | 0.23 | 0.58 | 0.47 | 0.52 | 0.48 | 0.39 |
| Suction Line (° C.) | | | | | | |
| Pressure Drop | 15.5 | 11.9 | 11 | 10.6 | 10.8 | 20.8 |
| Liquid Line (kPa) | | | | | | |
| Delta Tsat Liquid | 0.24 | 0.38 | 0.33 | 0.31 | 0.33 | 0.35 |
| Line (° C.) | | | | | | |

As will be understood by those skilled in the art, the retrofitted system of the present invention using the existing refrigerant flow lines provides acceptable performance in terms of the pressure drop of the indoor refrigerant in existing connecting lines. Based on industry standards, the maximum drop of saturation temperature in suction line is considered to be 2° F. (1.1° C.) and in the liquid line is 1° F. (0.56° C.). As reported in Table E3B above, these standards are satisfied in accordance with the retrofit methods of the present invention.

What is claimed is:

1. A refrigerant comprising at least about 95% by weight, based on all refrigerant components, of the following four components:
(e) from about 50.5% to about 52.5% by weight of HFO-1234yf,
(f) from about 35.5% to 41% by weight of HFC-134a;
(g) from 2.2% to 5.5% by weight of HFC-125; and
(h) from 3.8% to about 8% by weight of HFC-32, with said percentages being based on the total of (a) through (d).

2. The refrigerant of claim 1 consisting essentially of:
from about 50.5% to about 52.5% by weight of HFO-1234yf,
from about 35.5% to 41% by weight of HFC-134a;
from 2.2% to 5.5% by weight of HFC-125; and
from 3.8% to about 8% by weight of HFC-32.

3. The refrigerant of claim 1 consisting essentially of:
from 51% to 52.5% by weight of HFO-1234yf,
from 35.8% to 37.8% by weight of HFC-134a;
from 4.5% to 5.5% by weight of HFC-125; and
from 6 to 8% by weight of HFC-32.

4. The refrigerant of claim 1 consisting essentially of:
from 51% to 52.5% by weight of HFO-1234yf,
from 35.8% to 37.8% by weight of HFC-134a;
from 4.5% to 5% by weight of HFC-125; and
from 6% to 8% by weight of HFC-32.

5. A secondary loop residential refrigeration system comprising an indoor refrigerant according to claim 1.

6. The secondary loop residential refrigeration system of claim 5 having an outdoor refrigerant comprising one or more of propane, R454B or R32.

7. A method of retrofitting an existing residential heat pump air conditioning system that uses a vapor compression cycle with R410a as the refrigerant and a reversing valve to provide heating or cooling to the indoor air in a residence, said method comprising:
(a) providing an existing heat pump system comprising:
a. a compressor;
b. an outdoor heat exchanger for exchanging heat between outdoor air and said R410A refrigerant;
c. an indoor heat exchanger for exchanging heat between indoor air and said R410A refrigerant;
d. a reversing valve connected to the inlet and to the outlet of said compressor and to each of said outdoor heat exchanger and said indoor heat exchanger;
e. an expansion valve connected between said outdoor and said indoor heat exchanger;
(b) disconnecting said indoor heat exchanger from said expansion valve and from said reversing valve;
(c) providing an inter-circuit heat exchanger and connecting said inter-circuit heat exchanger to said expansion valve and to said reversing valve to provide a flow path of R410A refrigerant through said inter-circuit heat exchanger;
(d) creating a secondary loop circuit comprising said indoor heat exchanger and said inter-circuit heat exchanger; and
(e) providing in said secondary loop circuit an indoor refrigerant comprising at least about 95% by weight of the following components based on all refrigerant components:
a. from about 50.5% to about 52.5% by weight of HFO-1234yf,
b. from about 35.5% to 41% by weight of HFC-134a;
c. from 2.2% to 5.5% by weight of HFC-125; and
d. from 3.8% to about 8% by weight of HFC-32, with said percentages being based on the total of a. through d.

8. The method of claim 7 wherein said step of creating said secondary loop circuit further comprises including a liquid pump connected between said indoor heat exchanger and said inter-circuit heat exchanger.

9. The method of claim 8 wherein said step of creating said secondary loop circuit further comprises including a liquid pump alternatively connectable to said indoor heat exchanger or said inter-circuit heat exchanger.

10. The method of claim 9 wherein said step of creating said secondary loop circuit further comprises including a liquid receiver upstream of said pump.

11. The method of claim 10 wherein said step of creating said secondary loop circuit further comprises including a liquid receiver upstream of said pump and including piping and valving alternatively connectable to said indoor heat exchanger or said inter-circuit heat exchanger.

12. A method of retrofitting an existing split direct expansion vapor compression air conditioning system which has an indoor unit comprising an indoor heat exchanger, and outdoor unit comprising a compressor and an outdoor heat exchanger, refrigerant flow lines connected between said indoor and said outdoor units, and R410A in the indoor and outdoor units, said method comprising:
(a) disconnecting said refrigerant flow lines at or adjacent to the outdoor unit;
(b) removing said R410A refrigerant from said indoor unit and said outdoor unit;
(c) forming an outdoor refrigeration circuit comprising said compressor and said outdoor heat exchanger and a refrigerant with a GWP less than 750;
(d) forming an indoor loop refrigeration system comprising said indoor heat exchanger and a refrigerant comprising at least about 95% by weight of the following components based on all refrigerant components:
a. from about 50.5% to about 52.5% by weight of HFO-1234yf,
b. from about 35.5% to 41% by weight of HFC-134a;
c. from 2.2% to 5.5% by weight of HFC-125; and
d. from 3.8% to about 8% by weight of HFC-32, with said percentages being based on the total of a. through d.; and
(e) providing an inter-circuit heat exchanger which thermally connects said indoor loop and said outdoor loop.

13. The retrofit method of claim 12 wherein said indoor loop is connected to said outdoor loop using at least a portion of said existing refrigerant flow lines.

14. The retrofit method of claim 13 wherein said inter-circuit heat exchanger is located in said outdoor unit and wherein said outdoor circuit is connected to said inter-circuit heat exchanger using at least a portion of said existing refrigerant flow lines.

15. The retrofit method of claim 12 wherein after said forming step (c) said outdoor refrigerant comprises one or more of propane, R454B, R32 and combinations of these.

16. The retrofit method of claim 12 wherein after said forming step (d) said indoor refrigerant consists essentially of:
52%+0.5/−0.5% by weight of HFO-1234yf,
39%+0.5/−0.5% by weight of HFC-134a;
3%+0.3/−0.5% by weight of HFC-125; and
6%+0.5/−0.3% by weight of HFC-32.

17. The retrofit method of claim 15 wherein after said forming step (d) said indoor refrigerant consists essentially of:
52%+0.5/−0.5% by weight of HFO-1234yf,
39%+0.5/−0.5% by weight of HFC-134a;
3%+0.3/−0.5% by weight of HFC-125; and
6%+0.5/−0.3% by weight of HFC-32.

18. The retrofit method of claim 12 wherein after said forming step (d) said indoor refrigerant consists of:
51.4%+0.5/−0.5% by weight of HFO-1234yf,
40.4%+0.5/−0.5% by weight of HFC-134a;
4.1%+0.3/−0.5% by weight of HFC-125; and
4.1%+0.5/−0.3% by weight of HFC-32.

19. The retrofit method of claim 15 wherein after said forming step (d) said indoor refrigerant consists of:
51.4%+0.5/−0.5% by weight of HFO-1234yf,
40.4%+0.5/−0.5% by weight of HFC-134a;
4.1%+0.3/−0.5% by weight of HFC-125; and
4.1%+0.5/−0.3% by weight of HFC-32.

20. The retrofit method of claim 12 wherein after said forming step (d) said indoor refrigerant consists of:
51.3%+0.5/−0.5% by weight of HFO-1234yf,
36%+0.5/−0.5% by weight of HFC-134a;
5.2%+0.3/−0.5% by weight of HFC-125; and
7.5%+0.5/−0.3% by weight of HFC-32.
